(19) United States
(12) Patent Application Publication
(10) Pub. No.: US 2026/0179462 A1
(43) Pub. Date: Jun. 25, 2026

(54) WARNING DEVICE

(71) Applicant: ROYALTEK COMPANY LTD., TAOYUAN CITY (TW)

(72) Inventors: CHE-MING HSU, TAOYUAN CITY (TW); CHUN-LIANG LEE, TAOYUAN CITY (TW); KENG-FU HUANG, TAOYUAN CITY (TW)

(21) Appl. No.: 19/052,523

(22) Filed: Feb. 13, 2025

(30) Foreign Application Priority Data
Dec. 25, 2024 (TW) 113150572

(51) Int. Cl. G08B 5/00; G01S 7/41; G01S 13/28; G01S 13/53; G01S 13/58; G01S 13/89; G01S 13/931; G08B 3/10; G08B 5/38; G08G 1/16; G09F 13/16

(52) U.S. Cl. CPC G08B 5/006; G01S 7/41; G01S 13/282; G01S 13/53; G01S 13/583; G01S 13/89; G01S 13/931; G08B 3/10; G08B 5/38; G08G 1/164; G09F 13/16; G01S 2013/9316

(57) ABSTRACT

A warning device that combines a radar module with electronic control technology can accurately detect the velocity and the distance of an object around the warning device and provide dynamic warning (e.g., flashing or buzzing). The radar module, installed in an electronic component box, maintains a given distance from the ground to avoid echo interference from the ground, thereby reducing the noise of the collected point-cloud data. A controller extracts the relative velocity and the location of the object from the point-cloud data, selects dynamically approaching points to determine the relative distance and the direction of the object, and dynamically adjusts the flashing frequency of a warning lamp or turns on a buzzer based on the distance of the object relative to the radar module.

### BACKGROUND OF THE INVENTION

This application claims priority from the TW patent application No. 113150572 filed on 25 Dec. 2024, the content of which is incorporated by reference in its entirely.

### FIELD OF THE INVENTION

The present invention relates to radar technology applied to detect potential driving risks, particularly to a warning device applied to driving or stationary vehicles, which detects and analyzes surrounding objects that may collide.

### DESCRIPTION OF THE RELATED ART

The existing traffic safety equipment is usually implemented with a triangular lamp board that is used to alert the rear vehicles when a vehicle breaks down or stops temporarily. However, the main function of traditional triangle lamp boards depends on reflective materials or stationary warning lamps. The effectiveness of the lamp boards will be significantly reduced at night or in severe weather conditions (such as fog, rain and snow). This design, which depends on the reflection of external light sources, cannot provide sufficient visual warnings in conditions of insufficient ambient light, such that vehicles coming from behind easily fail to detect parked vehicles in time, thereby increasing the risk of accidents.

In recent years, some warning devices combining sound and light prompts with sensor technology have appeared on the market. For example, some products detect oncoming vehicles based on ultrasonic or infrared technology and combine sound and light prompts to provide warnings. However, these technical solutions still have the following problems. Firstly, in terms of detection accuracy, ultrasonic and infrared technologies are easily affected by environmental interference such as fog or obstacles during long-distance detection, so as to reduce detection accuracy. Besides, it is impossible to reliably determine the actual velocity and distance of the oncoming vehicle. Secondly, the warning mode of existing devices is usually relatively simple. It is impossible to automatically adjust the flashing frequency and brightness of the warning lamp according to the velocity, distance or direction of the oncoming vehicle, thereby resulting in limited application effects in dangerous scenarios such as highways.

In addition, the structural design of traditional warning devices lacks portability. Most triangular lamp boards are rigid structures, which occupy a large space and increase the inconvenience of storage and carrying in daily vehicle use. Such a design not only does not meet requirements for compactness of modern vehicles, but also reduces the efficiency of equipment use, especially in emergency scenarios for rapid deployment.

Finally, existing devices have insufficient intelligent applications. For example, most current warning systems only have basic sound and light warning functions and lack the ability to perform risk assessments on oncoming vehicles, such as predicting the oncoming vehicle's path or potential rear-end collision risks. In addition, existing devices are usually unable to interact with the vehicle communication system, thereby failing to implement the application of advanced technologies such as V2X (Vehicle-to-Everything) to further improve the warning range and its effect.

In summary, the traffic warning devices currently on the market still have room for improvement in detection accuracy, multi-functionality, structural design and intelligent application. The present invention provides a technological solution in order to improve these shortcomings.

### SUMMARY OF THE INVENTION

The primary objective of the present invention is to provide a warning device, which combines a radar module with electronic control technology, accurately detects the relative velocity and the distance of a target object, and turns on a warning lamp or adjusts its flashing frequency based on the detection result to improve traffic safety. The radar module maintains a given distance from the ground to reduce interference. A processing unit selects dynamically approaching points based on point-cloud data and calculates the distance and the location of the target object. When the target object approaches, the processing unit turns on the warning lamp or increases its flashing frequency.

According to the foregoing objective, the present invention provides a warning device, which includes:
a support stand;
a lamp board, having at least one warning lamp, arranged on the support stand;
an electronic component box arranged on the support stand;
a radar module arranged in the electronic component box and configured to detect at least one target object around the radar module to generate point-cloud data, wherein a distance between the radar module and the ground is greater than a given distance; and
a controller, comprising a processing module, electrically connected to the radar module and the at least one warning lamp, wherein the processing module is configured to:
   extract a frequency offset of each of data points in the point-cloud data and calculate a relative velocity and a direction of each of the data points based on a frequency relationship of Doppler effect to generate Doppler information;
   filter out the data points that fall beyond a detection range based on a distance threshold;
   filter out stationary points and dynamically moving away points of the data points and retain dynamically approaching data points based on the Doppler information;
   calculate a relative distance and a relative location of the at least one target object corresponding to the dynamically approaching points; and
   turn on the at least one warning lamp or increase a flashing frequency of the at least one warning lamp when the at least one target object approaches the radar module.

The support stand includes a support frame and a plurality of base legs. The support frame has at least one first connection point that is connected with the lamp board. Each base leg has at least one second connection point that is connected with the bottom surface of the support frame.

The support frame is folded at the at least one first connection point to overlap the lamp board. Each of the plurality of base legs rotates about the at least one second connection point to overlap the bottom surface of the support frame.

The lamp board is composed of three flat boards. Each of the flat boards is connected with each other using a hinge mechanism or a rotating shaft. Each flat board is provided with a fastening device. When the lamp board is unfolded, the three flat boards are fastened together to form a triangular structure.

In a storage state, the three flat boards are folded along the hinge mechanism or the rotating shaft to form a flat structure.

The warning device further includes a buzzer electrically connected to the controller. The controller controls the buzzer to emit warning sounds through a sound hole on the surface of the electronic component box.

The processing unit triggers a primary warning to generate a primary warning instruction when the distance of the at least one target object is less than a first preset value, the primary warning instruction starts the at least one warning lamp to flash at a low frequency. The processing unit triggers an enhanced warning to generate an enhanced warning instruction when the distance of the at least one target object is less than a second preset value. The enhanced warning instruction starts the at least one warning lamp to flash at a high frequency and starts the buzzer to sound abnormally.

The processing unit is configured to adjust the flashing frequency of the at least one warning lamp and the sound volume of the buzzer based on the present relative velocity of the at least one target object.

The processing unit is further configured to:
calculate the reflective area of the at least one target object corresponding to at least one of the dynamic points of the data points;
select the at least one target object with the reflective area greater than a preset value as a vehicle for potential rear-end collision; and
continuously collect the travel parameters of the vehicle, wherein the travel parameters include a location, a velocity, a direction, and a path.

The controller further comprises a prediction unit that is configured to:
collect the travel parameters of the vehicle;
combine with new point-cloud data to generate the predicted trajectory of the vehicle based on the travel parameters; and
immediately generate the enhanced warning instruction when determining that the predicted trajectory of the vehicle overlaps the location of the warning device.

The prediction unit is further configured to:
collect the locations of other target objects around the vehicle; and
immediately generate the enhanced warning instruction when determining that the predicted trajectory of the vehicle after avoiding the other target objects overlaps the location of the warning device.

The warning device further includes a communication unit that generates and transmits a collision warning message to at least one adjacent communication device when the enhanced warning instruction is generated.

Compared to the conventional technology, the present invention combines many technical features to achieve the significant technical effects that include:
1. High-precision environmental detection and instant response capabilities: The warning device of the present invention combines a millimeter-wave radar module with a controller to accurately detect the distance and velocity information of the target object (such as a vehicle coming from behind), and uses the processing unit to filter and analyze the point-cloud data, thereby effectively identifying and targeting dynamic objects that pose the risk of rear-end collision. Based on the automated risk assessment and hierarchical warning mechanism, visual and auditory alarms can be generated instantly to help drivers in rear vehicles respond in advance and reduce the risk of traffic accidents.
2. Multi-level dynamic warnings that improve safety: The warning device adopts a dynamically adjusted warning solution. According to the changes in the distance and velocity of the target object, the flashing frequency of the warning lamp and the volume of the buzzer are controlled to provide multi-level warning signals when the target object is in different distances. Especially in high-risk situations (e.g., when the rear vehicle is traveling at high velocity or changing lanes), an enhanced warning signal can be triggered on to ensure that the driver can quickly perceive changes in the surrounding environment, greatly improving the warning effect.
3. Intelligent data processing and target predicting functions: The warning device uses the processing unit to select dynamic points and target the object, accurately detects the object's travel parameters and predicts its possible trajectory based on the path analyzing technology of the prediction unit. The warning device tracks target objects that pose a high risk. This not only enables early warning of high-risk target objects but also avoids the need to recalculate resources due to the need to recalculate the point cloud data. Recalculating the resources may lead to gaps in detecting high-risk target objects.
4. Modular design that improves the adaptability and convenience of the device: The warning device adopts a modular design, including the foldable stand and the portable electronic component box. The modular design that can be rapidly unfolded and stored adapts to the needs of various traffic environments. The electronic component box integrates the radar module, the controller, and the battery module, so as to improve the integration of the device and reduce the complexity of installation and operation, thereby enhancing its practicality in emergency scenarios.
5. Intelligent connection and expandable warning functions: By the communication unit, the present invention can transmit the rear-end collision warning signal to the driver's communication device (such as a smartphone) or the communication device of the surrounding vehicles (such as a vehicle-mounted system or a smartphone), thereby expanding the warning range and enhancing the alertness of the drivers of oncoming vehicles. The communication technology of the communication device that directly transmits signals to the surrounding vehicles is designed based on the V2X (Vehicle-to-Everything) concept, which can enhance the intelligent application level of the device and provide possibilities for the development of intelligent traffic systems in the future.

Below, the embodiments are described in detail in cooperation with the drawings to make easily understood the technical contents, characteristics and accomplishments of the present invention.

### BRIEF DESCRIPTION OF THE DRAWINGS

FIG. 1 is a schematic diagram illustrating a warning device according to an embodiment of the present invention;

FIG. 2 is a schematic diagram illustrating a warning device that is folded according to an embodiment of the present invention;

FIG. 3 is a schematic diagram illustrating a warning device that is folded according to another embodiment of the present invention;

FIG. 4 is a schematic diagram illustrating the interior of an electronic component box according to an embodiment of the present invention;

FIG. 5 is a schematic diagram illustrating electronic components according to an embodiment of the present invention;

FIG. 6 is a schematic diagram illustrating electronic components according to another embodiment of the present invention;

FIG. 7 is a schematic diagram illustrating the radar module of a warning device in a location according to an embodiment of the present invention;

FIG. 8 is a schematic diagram illustrating the radar module of a warning device in another location according to an embodiment of the present invention;

FIG. 9 is a diagram illustrating point-cloud data generated by the radar module of a warning device close to the ground according to an embodiment of the present invention;

FIG. 10 is a diagram illustrating point-cloud data generated by the radar module of a warning device that is 50 cm from the ground according to an embodiment of the present invention; and

FIG. 11 is a warning flowchart according to an embodiment of the present invention.

### DETAILED DESCRIPTION OF THE INVENTION

Reference will now be made in detail to embodiments illustrated in the accompanying drawings. Wherever possible, the same reference numbers are used in the drawings and the description to refer to the same or like parts. In the drawings, the shape and thickness may be exaggerated for clarity and convenience. This description will be directed in particular to elements forming part of, or cooperating more directly with, methods and apparatus in accordance with the present disclosure. It is to be understood that elements not specifically shown or described may take various forms well known to those skilled in the art. Many alternatives and modifications will be apparent to those skilled in the art, once informed by the present disclosure.

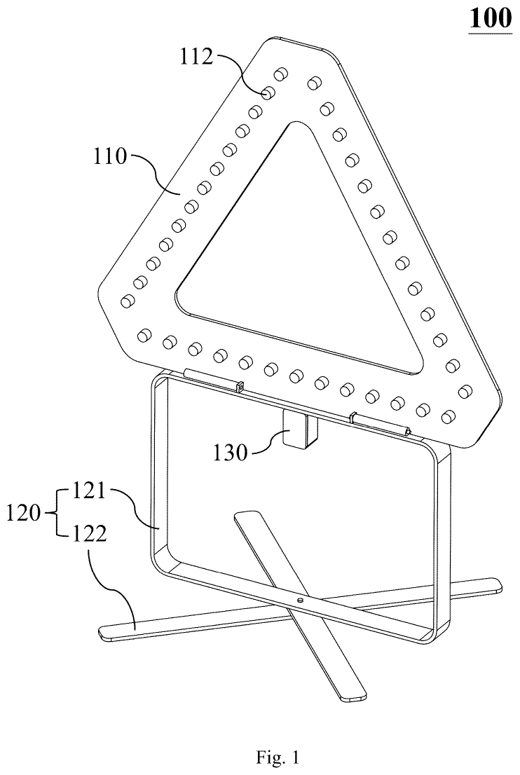

Please refer to FIG. 1. FIG. 1 is a schematic diagram illustrating a warning device according to an embodiment of the present invention.

According to an embodiment, a warning device 100 includes a lamp board 110, a support stand 120, and an electronic component box 130. The lamp board 110, arranged on the upper part of the device, uses a warning lamp 112 to convey warnings as much as possible, thereby providing a high-visibility warning function. The lamp board 110 can have the shape of a triangle or any other shape. The lamp board 110 is arranged on the support stand 120. The support stand 120 can stably support the lamp board 110. The electronic component box 130 is arranged on the support stand 120. The interior of the electronic component box 130 is installed with a radar module 140 and a controller 150.

In the embodiment, the lamp board 110 is the main visual warning structure of the device. In addition to providing at least one warning lamp 112, the lamp board 110 can also have a reflective surface to adapt to various lighting conditions or a state where the warning lamp 112 cannot be turned on normally. The electronic component box 130 is arranged on the top of the support stand 120. The radar module 140 in the electronic component box 130 can perform 360-degree detection. In the embodiment, the radar module 140 detects objects in a specific direction (such as detecting rear vehicles). Thus, the radar module 140 can be installed in a location close to a cover 131 (i.e., the cover 131 faces toward the rear vehicles) to ensure that the radar waves do not be blocked by other electronic components. The electronic component box 130 is arranged on the support stand 120 such that radar signals (i.e., millimeter waves) emitted by the radar module 140 maintains a suitable distance from the ground. Thus, the distortion of the radar signal due to refraction is reduced to improve the detection accuracy.

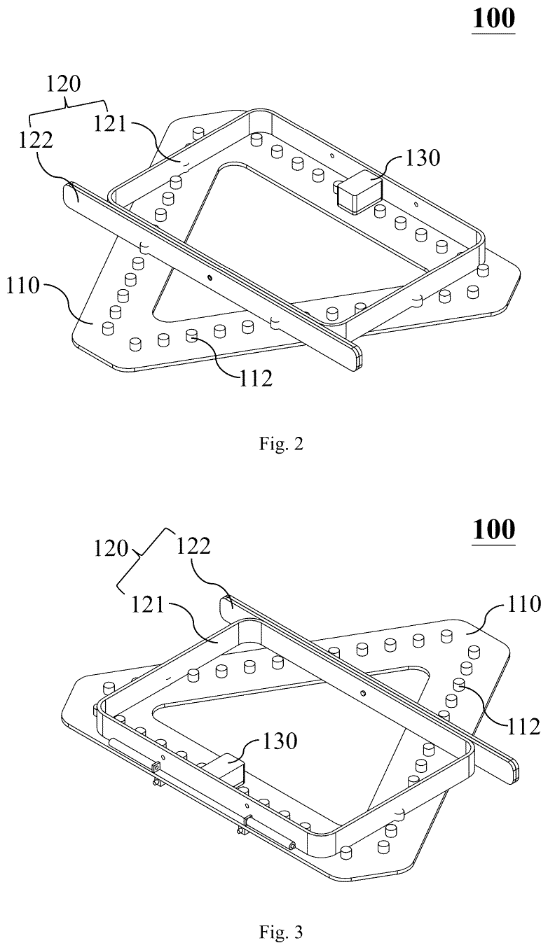

Please refer to FIGS. 1-3. FIG. 2 is a schematic diagram illustrating a warning device that is folded according to an embodiment of the present invention. FIG. 3 is a schematic diagram illustrating a warning device that is folded according to another embodiment of the present invention.

According to another embodiment, the support stand 120 includes a support frame 121 and a plurality of base legs 122. The support frame 121 has at least one first connection point that is connected with the lamp board 110. Each base leg 122 has at least one second connection point that is connected with the bottom surface of the support frame 121. As illustrated in FIG. 1, the support frame 121 and the base legs 122 provide stable support functions in an unfolding state. Thus, the lamp board 110 is stabilized on the ground to achieve the best viewing angle. As illustrated in FIGS. 2-3, the support frame 121 is folded at the first connection point to overlap the lamp board 110 in a storage state. Each base leg 122 can rotate about the second connection point to overlap the bottom surface of the support frame 121 to reduce space occupancy.

In the embodiment, the support stand 120 can be a multi-section telescopic structure so that the height of the device can be adjusted to adapt to different application scenarios. The support frame 121 may be made of lightweight and durable aluminum alloy or carbon fiber. The base leg 122 may have an end made of rubber to enhance friction and stability.

According to another embodiment, the lamp board 110 may be composed of three flat boards. Each of the flat boards is connected with each other using a hinge mechanism or a rotating shaft. The edge of each flat board is provided with a fastening device for fixing after unfolding the lamp board 110. When the lamp board 110 is unfolded, the three flat boards are fastened together to form a stable triangular structure, thereby achieving all-round visibility.

Furthermore, in the storage state, the three flat boards are folded along the hinge mechanism or the rotating shaft to form a flat structure for easy storage. The lamp board 110 may be made of high-strength plastic or metal plate. Reflective material or waterproof coating may be further added to the surface of the lamp board 110 to enhance the all-weather application effect. The fastening mechanism can be replaced with a magnetic fixing device to improve the convenience of operation.

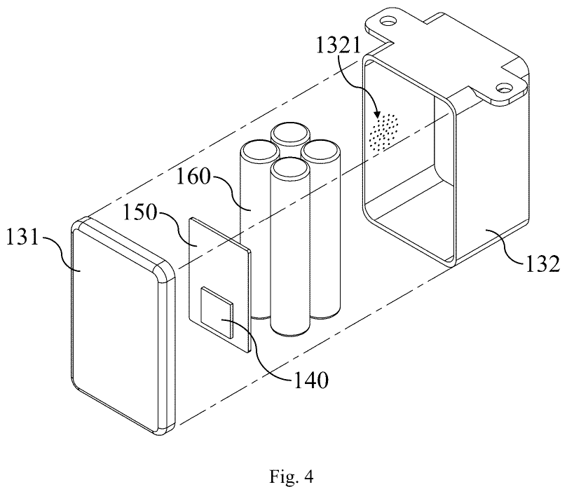

Please refer to FIG. 4. FIG. 4 is a schematic diagram illustrating the interior of an electronic component box according to an embodiment of the present invention.

According to another embodiment, as illustrated in FIG. 4, a battery module 160 is arranged in the electronic component box 130. The battery module 160 is close to a box body 132 (i.e., away from the cover 131 to prevent obstructing the radar module 140 from emitting and receiving radar signals). The battery module 160 provides stable power for the radar module 140 and the controller 150. The battery module 160 may be implemented with a rechargeable lithium battery or may be combined with a solar panel to extend the battery life.

In the embodiment, in some applications, a replaceable battery structure can be used to help users replace the power source after long-term use. In addition, a power monitoring unit may be integrated into the battery module 160 and controlled by the controller 150 to display the remaining power. Alternatively, the power monitoring unit triggers a low-power notification when the power is low, thereby reminding the user of charging or replacing the battery.

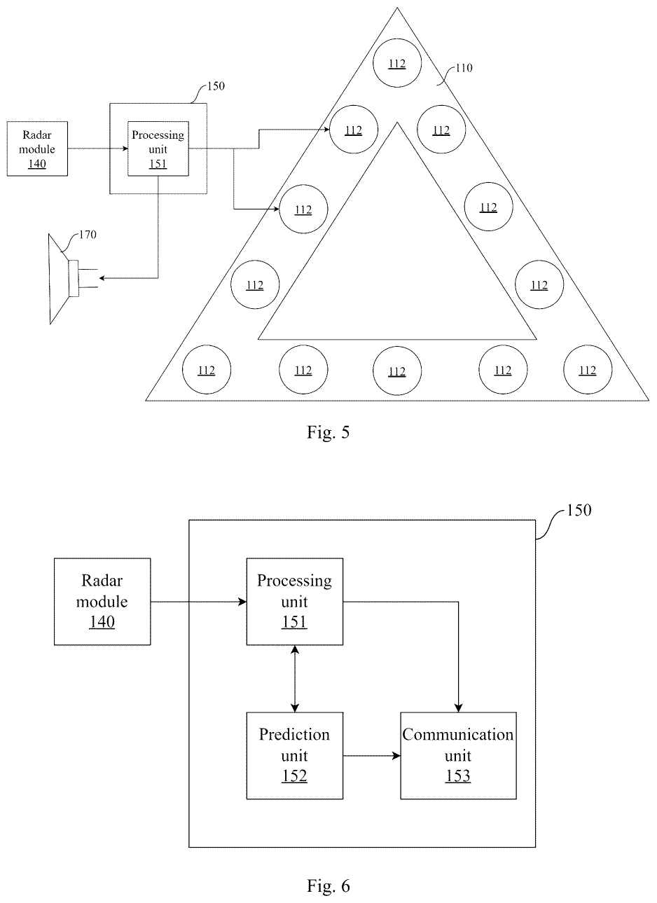

Refer to FIGS. 4-5. FIG. 5 is a schematic diagram illustrating electronic components according to an embodiment of the present invention.

According to further embodiment, as illustrated in FIGS. 4-5, the warning lamp 112 may be embedded into the lamp board 110 or arranged on the surface of the lamp board 110. The controller 150 controls the flashing mode of the lamp board 110. The warning lamp 112 may be implemented with a high-brightness LED lamp combined with a multi-color lamp to achieve warning effects in different situations. For example, a low-frequency red flashing light may be used for a long-distance primary warning, and a high-frequency orange or white flashing light may be used for a short-distance enhanced warning. In addition, a buzzer 170 that is arranged in the electronic component box 130 emits warning sounds through the sound hole 1321 of the box body 132. The volume and frequency of the warning sounds are automatically adjusted based on the warning level. For example, the buzzer 170 emits low-frequency continuous sounds at a long distance and emits high-frequency intermittent sounds at a short distance. In order to enhance the effect, a directional buzzer 170 may be further installed to focus the sounds in a specific direction to improve effectiveness.

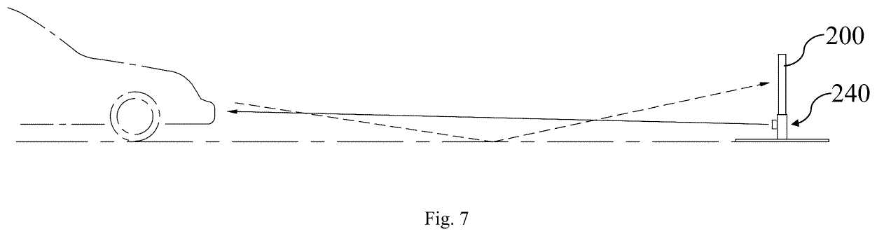

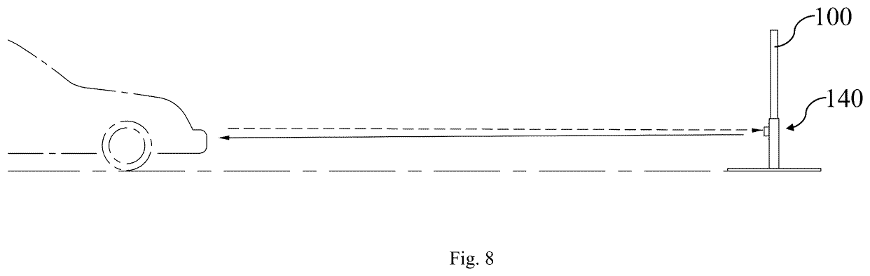

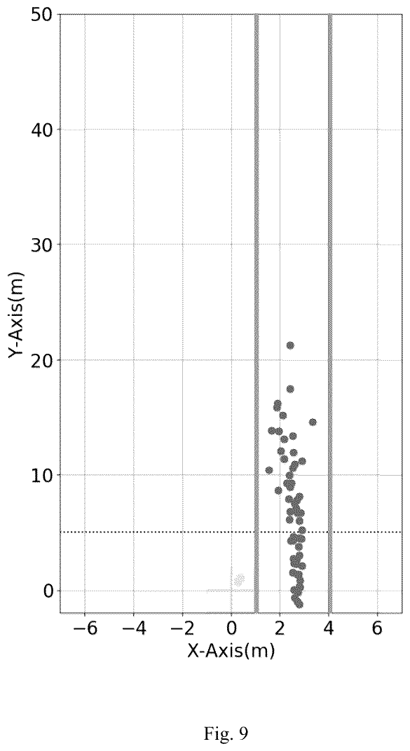

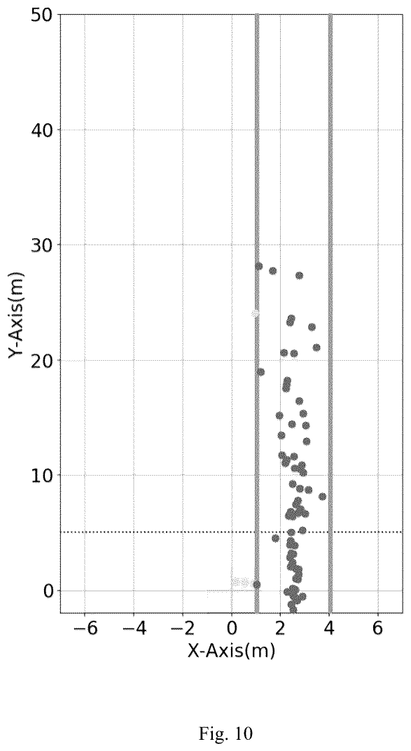

Please refer to FIGS. 6-10. FIG. 6 is a schematic diagram illustrating electronic components according to another embodiment of the present invention. FIG. 7 is a schematic diagram illustrating the radar module of a warning device in a location according to an embodiment of the present invention. FIG. 8 is a schematic diagram illustrating the radar module of a warning device in another location according to an embodiment of the present invention. FIG. 9 is a diagram illustrating point-cloud data generated by the radar module of a warning device close to the ground according to an embodiment of the present invention. FIG. 10 is a diagram illustrating point-cloud data generated by the radar module of a warning device that is 50 cm from the ground according to an embodiment of the present invention.

According to yet another embodiment, as illustrated in FIG. 6, the warning device 100 combines the software functions of the radar module 140 and the processing unit 151, such that the hardware and the software accurately detect the surrounding environment and provide dynamic warnings. The processing unit 151 may be an embedded micro-processor or a digital signal processor (DSP) that has an ability to process the point-cloud data in real time. The processing flow of the combination of hardware and software is introduced as follows:

### 1. Receiving and Processing Point-Cloud Data

The radar module 140 that is installed in the electronic component box 130 maintains a give height from the ground to effectively reduce echo interference from the ground and improve the detection stability of a millimeter wave radar.

As illustrated in FIG. 7, take another warning device 200 for comparison. When the radar module 240 of the warning device 200 is very close to the ground, many refractive phenomena occur after the radar waves touch the ground during a propagation process. These refracted echoes often enter into the radar module 240 due to the angle deviation, such that the data received by the radar module 240 are mixed with a large amount of background information of non-target objects, thereby significantly reducing the accuracy of radar detection, especially in high-velocity environments. Specifically, when the height of the radar module 240 is lower than 50 cm, the radar beam will be affected by the reflective characteristics of the ground material. For example, on a slippery asphalt road or the metal ground with high reflectivity, multiple refractions of echoes may simulate false dynamic points to increase the computational burden of the processing unit 151 and prolong the time for selecting target objects. In contrast, as illustrated in FIG. 8, the radar module 140 of the warning device 100 is a certain height from the ground. For common millimeter wave radars (with an operating frequency between 24 GHz and 77 GHZ), the height from the ground is usually at least 50 cm. Before reaching the ground, the contact area will be reduced due to the vertical emitting angle of the radar wave, thereby greatly reducing the refractive phenomena of the echoes. Therefore, the higher installation location of the radar module 140 expands the effective detection range of the radar wave, which can significantly improve data accuracy and computing efficiency, especially when determining distant target objects.

Then, the processing unit 151 receives the point-cloud data generated by the radar module 140. The point-cloud data includes the locations, distances, and echo intensities of objects in the surrounding environment. In order to accurately analyze the motion characteristics of each data point, the processing unit 151 performs the following operations.

The processing unit 151 extracts the frequency offset of each data point and calculates the relative velocity and the direction of each data point based on the frequency relationship of the Doppler effect. The processing unit 151 converts the frequency offset into a velocity vector.

The processing unit 151 generates a set of Doppler information that can clearly distinguish the moving directions of objects (i.e., approaching or moving away directions).

Using the support stand 120, the foregoing steps can ensure that the radar module 140 can operate stably on different terrains and obtain accurate point-cloud data.

The “frequency offset” is a signal feature generated based on the Doppler effect of the radar module 140 and is used to analyze the motion state of the target object relative to the radar. When the radar module 140 emits electromagnetic waves and the wave beam encounters a moving target object, the wave beam is reflected back to the radar. The reflected wave will change in frequency based on the moving velocity and direction of the target object. This change is called a frequency shift. In the embodiment, the point-cloud data generated by the radar module 140 includes not only the spatial coordinates of each point (such as distance and direction), but also the frequency offset information of each point. The frequency offset reflects the relative velocity of the target object. The frequency offset is extracted from the radar echo based on signal processing methods such as Fast Fourier Transform (FFT). Therefore, the embodiment combines the extracted frequency offset value with the frequency relationship of Doppler effect to calculate the relative velocity and direction of each target object. The relative velocity information can be further used to distinguish dynamic points from stationary points and select moving away dynamic points, thereby retaining only approaching dynamic points. For example, when the radar module 140 detects that the frequency offset of a certain point is a negative value, it means that the point is approaching the radar system. Conversely, when the frequency offset is a positive value, it means that the point is moving away from the radar system. The information, combined with the distances and directions of the target objects, can achieve accurate tracking and grouping analysis of the target objects.

### 2. Selecting Dynamic Points and Extracting Target Objects

Using the following manners, the processing unit 151 selects the meaningful data based on the received point-cloud data.

The processing unit 151 filters out the data points that fall beyond a detection range based on a distance threshold and retains the data points in a given range. The distance threshold is adaptable according to environments. For example, the data points beyond 100 meters are automatically excluded.

The processing unit 151 filters out the stationary points and the dynamically moving away points and retains the data points whose velocities are negative as the data of the objects close to the device.

A method for removing unnecessary data points may be, for example, selecting unnecessary data points based on the coordinates (e.g., x, y) of the target object and its Doppler information. The specific methods and examples are introduced as follows.

The signal filtering based on distance and Doppler information includes coordinate detection and Doppler information analysis. Coordinate detection involves using a millimeter-wave radar to scan an unknown target object, thereby obtaining the (x, y) coordinates of the target object (i.e., the plane location within the detection range of the radar). Based on the Doppler effect formula, Doppler information analysis provides the velocity information of the target object relative to the radar, such as a positive value, a negative value, or a zero value.

Positive value: target object is moving away;

Negative value: target object is approaching; and

Zero value: target object is relatively stationary.

Using coordinate detection and Doppler information analysis, objects moving away from the target object or stationary objects irrelevant to the target object are filtered out, thereby retaining only approaching target objects that affect the warning function.

Refer to Table.1. Assume that a millimeter-wave radar detects the following data points.

TABLE 1
Data points are obtained based coordinate
detection and Doppler information.

| | | Doppler | Data point |
|---|---|---|---|
| | | information | (target |
| Coordinates (x, y) | Distance (m) | (velocity m/s) | object)state |
| (1, 2) | 2.236 | −2.5 | Approaching |
| | | | target object |
| (5, 8) | 9.43 | 1.0 | Moving away |
| | | | target object |
| (10, 10) | 14.14 | 0.0 | Stationary object |
| | | | (noise) |
| (15, 5) | 15.81 | −0.5 | Approaching |
| | | | target object |

For example, the process of determining the states of the data points obtained in Table 1 may include the following steps:

Selecting moving away target objects: The radar determines that the target object is moving away based on the Doppler information (whose velocity is positive) and removes the coordinates (5, 8).

Filtering out stationary objects: The object whose Doppler information is zero has coordinates of (10, 10) and serves as a stationary object. The object is nonthreatening and filtered out.

Retaining approaching target points: The approaching target objects whose coordinates include (1, 2) and (15, 5) remain. The approaching target objects are located in the warning range and used as valid data points.

Please refer to FIGS. 9-10. FIGS. 9-10 show the detection effect of the radar module of a warning device installed at different heights. FIG. 9 is a diagram illustrating point-cloud data generated by the radar module of a warning device close to the ground (i.e., at a height of 0 cm). FIG. 10 is a diagram illustrating point-cloud data generated by the radar module of a warning device that is 50 cm from the ground. In the test, the moving object is at least one vehicle (i.e., target object), which gradually approaches the warning device from a distance of 30 meters.

As illustrated in FIG. 9, when the radar module is close to or adjacent to the ground (such as the radar module 240 in FIG. 7), the farthest data point detected only appears at 21 meters. The quantity and accuracy of the data points are significantly reduced. Possible reasons are described as follows. Firstly, the reason is the blocking effect of the radar's visible range. Since the radar module is close to the ground, the visible range of the radar wave is blocked by the ground, thereby reducing the effective detection range. This blocking effect makes it impossible for the radar module to fully exert its original detection performance. Secondly, the reason includes the multi-path effect and the ghost effect. When radar waves propagate near the ground, multi-path reflections may occur. For example, some radar waves may hit the ground first, then reflect to the target object, and finally return to the receiving end of the radar module. During this process, the radar receives directly reflected echoes and indirectly reflected echoes, resulting in overlapping false target points (i.e., ghost points) in the data.

Specifically, in a radar module that emits a frequency modulated continuous wave (FMCW), ghost points appearing in the range-velocity map (Rvmap) are generated after the range fast Fourier transform (Range FFT) and the Doppler fast Fourier transform (Doppler FFT). The ghost points may be mixed with real data points to exacerbate the interference, especially when there are road trees or other objects such as parked vehicles in the test environment. When the radar module is located at a lower height, this multipath effect increases significantly to affect the correct interpretation of the target object's coordinates and state. In addition, the radar module of the present embodiment also dynamically adjusts the detection threshold based on the constant false alarm rate (CFAR). As a result, when ghost points and noise increase, it may be difficult for the processing unit to accurately select valid target data.

As illustrated in FIG. 10, when the radar module is 50 cm from the ground (the radar module 140 in FIG. 8 is at a certain distance from the ground), the farthest data point detected appears at 28 meters. Moreover, the distribution of data points is relatively sparse (because there are fewer ghost points), which can effectively track the trajectory close to the vehicle. This result shows that it can avoid excessive echo interference from the ground and improve the ability to accurately detect target objects when the radar module maintains a suitable distance from the ground. In addition, installing the radar at a moderate height can reduce the refraction of radar waves by ground materials, thereby improving the reliability of the echo signal.

### 3. Implementation of Hierarchical Warnings

After the target object is determined, the processing unit 151 generates hierarchical warnings based on the relative distance and location of the target object. The specific steps include:

Primary warning: The processing unit 151 triggers a primary warning to generate a primary warning instruction when the distance of the target object is less than a first preset value. In response to the primary warning instruction, the controller 150 starts the warning lamp 112 to flash at a low frequency, thereby attracting the attention of oncoming drivers.

Enhanced warning: The processing unit 151 triggers an enhanced warning to generate an enhanced warning instruction when the distance of the target object is less than a second preset value. In response to the enhanced warning instruction, the controller 150 starts the warning lamp 112 to flash at a high frequency and starts the buzzer 170 to sound abnormally.

The warning lamp 112 in the hardware structure is arranged within the triangular structure of the lamp board 110 to form a continuous light source. The buzzer 170, arranged in the electronic component box 130, emits warning sounds through a sound hole 1321. This combination of sound and light warning method improves the intensity of the warning effect and the wide coverage.

In summary, the test results of FIGS. 7 to 10 have shown that the radar module 140 of the warning device 100 arranged at a certain distance from the ground not only significantly expands the effective detection range of the radar wave, but also effectively reduces interference caused by reflections from the ground and multipath problems. More importantly, the location characteristics of the radar module 140 are combined with the overall structure of the warning device 100, which can achieve the dual technical effects of accurately detecting the target object and providing an immediate warning in actual applications. Specifically, the radar module 140 that is a certain distance from the ground can accurately capture the approaching target object. The processing unit 151 immediately analyzes the relative velocity, direction and location of each data point in the point-cloud data to dynamically adjust the warning of the warning lamp or the buzzer, such as increasing the flashing frequency or activating the sound warning.

According to another embodiment, the warning device 100 can dynamically adjust the flashing frequency of the warning lamp 112 and the volume of the buzzer 170 based on the travel parameters of the target object to achieve a more targeted warning effect. The processing unit 151 obtains the surrounding point-cloud data from the radar module 140. After filtering and analyzing the point-cloud data and targeting at least one target object, it makes real-time adjustments based on the velocity and distance of the target object. These adjustments ensure the adaptability of the warning lamp 112 and the buzzer 170 in different situations.

For example, when the velocity of the target object is high (e.g., more than 15 meters per second), the processing unit 151 increases the flashing frequency of the warning lamp 112 to 6 times per second to attract the driver's attention, which is particularly suitable for Highway and other environments. At low or medium velocity (such as 5 to 15 meters per second), the flashing frequency is maintained at 3 times per second to avoid excessive warnings and message fatigue. In addition, when the target object is very close (e.g., less than 20 meters), the warning lamp 112 can be switched to a continuous lighting mode to create a strong visual stimulation to help the driver respond quickly.

The volume of the buzzer 170 is adjusted based on the distance of the target object. When the target is at a distance greater than 50 meters but less than 100 meters, the volume is set to 30 decibels to provide a mild reminder. When the distance is further shortened to 20-50 meters, the volume is increased to 60 decibels to deliver a clear warning message. If the target object is at a distance less than 20 meters in a high-risk situation, the volume of the buzzer 170 rises to a maximum value of 90 decibels to remind the driver to take emergency measures immediately. This hierarchical control mechanism effectively avoids interference from false alarms or excessive warnings, thereby ensuring that the warning sound effect corresponds to the actual risk level.

To further enhance the warning effect, the warning lamp 112 and the buzzer 170 in the embodiment can work synchronously. For example, when a target object approaches at high velocity and the distance is shortened to a dangerous range, the high-frequency flashing light generated by the warning lamp 112 and the high-decibel volume generated by the buzzer 170 occur synchronously to provide dual sensory stimulation and enhance the warning effect. This collaborative working mode can help drivers quickly perceive danger and take appropriate actions in emergency situations. In addition, the embodiment can further expand the technical application. For example, the warning lamp 112 is provided with an RGB full-color light source. According to the risk level of the target object, the color of the light generated by the warning lamp 112 is changed, such as green for low risk, orange for medium risk, and red for high risk. The change in the light color can further enhance the recognition of warnings. The buzzer 170 may also be combined with a voice module to play voice prompts in high-risk situations to help the driver quickly understand the content of the warning message.

According to further embodiment, the warning device 100 uses a more accurate analysis method corresponding to potential rear-end collision vehicles, calculates the reflective area of the target object and combines it with dynamic parameters to select and identify the target object that may cause the risk of rear-end collision, thereby enhancing the traffic warning function.

In implementation, the radar module 140 captures the point-cloud data of the target object. The processing unit 151 calculates the reflective area corresponding to at least one retained dynamic point. The reflective area is calculated based on the intensity distribution of the radar echo signal and the number of dynamic points to reflect the relative size and material characteristics of the target object. For example, large vehicles such as trucks or buses usually have a larger reflective area than cars or motorcycles. Thus, they can be selected by setting a preset threshold (such as a reflective area greater than 10 m²).

After selecting the target objects, the processing unit 151 marks the target objects whose reflective areas exceed a preset value as potential rear-end collision vehicles. This selecting method based on reflective area can effectively eliminate the interference of small objects (such as animals or garbage) on the determination of the processing unit 151 and focus on vehicles that may pose a threat to traffic safety.

For the selected potential rear-end collision vehicles, the processing unit 151 begins to continuously collect their travel parameters, including but not limited to location, velocity, direction and relative distance. For example, when the target vehicle approaches at a high velocity and its direction is parallel to the lane where the warning device 100 is located, the processing unit 151 will determine that the target vehicle has a higher risk of rear-end collision and trigger further warning steps. In addition, for multi-target scenarios, the processing unit 151 can perform hierarchical management on vehicles with different reflective areas, giving priority to processing the largest threatening targets, so as to reasonably allocate system operation resources.

To improve the warning accuracy, the embodiment may also combine multiple echo features for cross-validation, such as checking the stability and frequency variations of the echoes to ensure that the selected vehicle is an actual threat. In addition, when the radar module 140 receives the point-cloud data of the multiple target objects, the processing unit 151 can use the Kalman filter to predict the travel parameters of the potential rear-end collision vehicle to determine whether the future motion trajectory of the potential rear-end collision vehicle overlaps the location of the warning device 100.

The embodiment can also cooperate with other sensors (such as cameras or ultrasonic sensors) to provide the images or acoustic information of the target object for auxiliary identification. For example, in high-traffic scenarios, multi-sensor fusion technology can be used to further improve the accuracy of identifying and tracking potential rear-end collision vehicles. At the same time, for specific scenarios (such as tunnels or night driving), the processing unit 151 can also adjust the preset value of the reflective area to adapt to requirements for detecting different environments.

Therefore, the embodiment provides an efficient identification and accurate analysis method for potential rear-end collision vehicles by calculating the reflective area and collecting the dynamic parameters, which can significantly improve the intelligence level of traffic safety warnings.

According to another embodiment, the warning device 100 calculates a predicted trajectory by combining the vehicle's travel parameters with the point-cloud data, thereby effectively improving the recognition accuracy of the potential rear-end collision vehicle. The warning device 100 adopts different analysis methods to deal with different traffic scenarios.

In the embodiment, the processing unit 151 obtains the vehicle's travel parameters, which include its current location, velocity, and motion direction.

After obtaining the travel parameters, the prediction unit 152 further integrates the latest point-cloud data to generate the predicted trajectory of the vehicle. The predicted trajectory is obtained by calculating the motion direction and distance of the vehicle within a certain period of time in the future. A kinematic model (such as a Kalman filter or a Markov chain model) is used for dynamically simulating the predicted trajectory. For example, when a vehicle approaches at high velocity and keeps straight-line motion, its predicted trajectory will appear as a smooth straight line. If the direction of the vehicle changes frequently, the prediction unit 152 will mark the path as an unstable trajectory and increase the data update frequency.

Once the predicted trajectory overlaps with the location of the warning device 100, the controller 150 immediately triggers an enhanced warning instruction. The instruction will start the high-frequency flashing warning lamp 112 and the abnormal sounding buzzer 170 to remind the driver to timely take evasive action.

In addition, the prediction unit 152 analyzes more complex traffic scenarios and collects the location information of other target objects around the vehicle. These target objects may include other vehicles, roadblocks or pedestrians in adjacent lanes. The prediction unit 152 runs a full scan by superimposing multiple point-cloud data and generates the spatial distribution map of the target objects.

When the vehicle's motion trajectory shows that it may avoid other target objects, the prediction unit 152 simulates the vehicle's behavior based on the dynamic travel parameters. For example, when the vehicle faces an obstacle ahead, the prediction unit 152 generates a predicted trajectory after the vehicle switches lanes to avoid the obstacle. If the avoidance trajectory overlaps with the location of the warning device 100, the controller 150 immediately generates an enhanced warning instruction to prompt the relevant vehicles to take action as soon as possible.

The foregoing method is applicable to dynamic scenarios with multiple target objects, especially when a vehicle may change its travel path due to external interference. Early warnings can be provided by predicting the vehicle's avoidance behavior.

According to another embodiment, the controller 150 further includes a communication unit 153, which transmits a rear-end collision warning message to at least one adjacent communication device when generating the enhanced warning instruction. The communication unit 153 is arranged in the electronic component box 130 of the warning device 100 and connected with the controller 150 to achieve efficient and reliable message transmission. The communication unit 153 supports multiple communication protocols, including those of vehicle-to-vehicle (V2V), vehicle-to-infrastructure (V2I), and Bluetooth or Wi-Fi technology, to meet the requirements of different scenarios.

Specifically, when the processing unit 151 generates the enhanced warning instruction, the communication unit 153 is immediately activated to transmit a rear-end collision warning message composed of the following information to the surrounding communication devices.

Firstly, the message includes the real-time motion parameters of the oncoming vehicle, such as velocity and distance, which are provided by the radar module 140 and calculated by the processing unit 151. Secondly, the location information of the warning device 100 is provided by a global positioning system (GPS) to ensure that the receiving end can accurately locate the warning source. In addition, the message will also indicate the level of potential rear-end collision risk (such as high, medium, or low) so that the recipient can take appropriate measures quickly based on the risk level.

Furthermore, the communication unit 153 can transmit messages to a variety of receiving devices. For example, the vehicle-mounted communication system can receive messages and display relevant warning messages on the driver's display screen, or alert the driver to potential dangers through voice prompts. At the same time, the smartphone can also be used as a receiving device that uses the application program to transmit notifications or alarms, thereby alerting the vehicle driver. In addition, the communication unit 153 can also transmit information to smart road signs or traffic management systems to activate wide-area warnings on specific road sections.

In specific applications, the communication unit 153 can be designed with multiple message transmission modes to adapt to the requirements of different distances and scenarios. When the vehicle is close to the communication device 153, short-range wireless communication modes (such as Bluetooth or Ultra-wideband) can be used to transmit messages directly to surrounding vehicle. When the vehicle is far apart from the communication device 153 or there are multiple vehicles, the communication unit 153 can use the Long Term Evolution (LTE) or 5G network to transmit the warning message to the cloud, which will then forward it to the relevant recipients.

In order to enhance the functionality of the system, the application of the communication unit 153 may be further expanded in the embodiment. For example, a bidirectional communication function is implemented. The communication unit 153 can not only send warning messages but also receive feedback information from other vehicles or traffic facilities, thereby forming a complete Internet of vehicles. In addition, the communication unit 153 can also combine functions for storing and analyzing data to save all warning records to a built-in storage unit or the cloud, thereby providing a basis for subsequent traffic event analysis.

The embodiment integrates the communication unit 153 into the warning device 100 to achieve functional expansion from local warning to wide-area warning, thereby improving the warning range of rear-end collision risk and the transmission efficiency. It not only helps drivers respond quickly to dangerous situations but also provides traffic managers with a more reliable safety warning solution, thereby effectively reducing the incidence of traffic accidents.

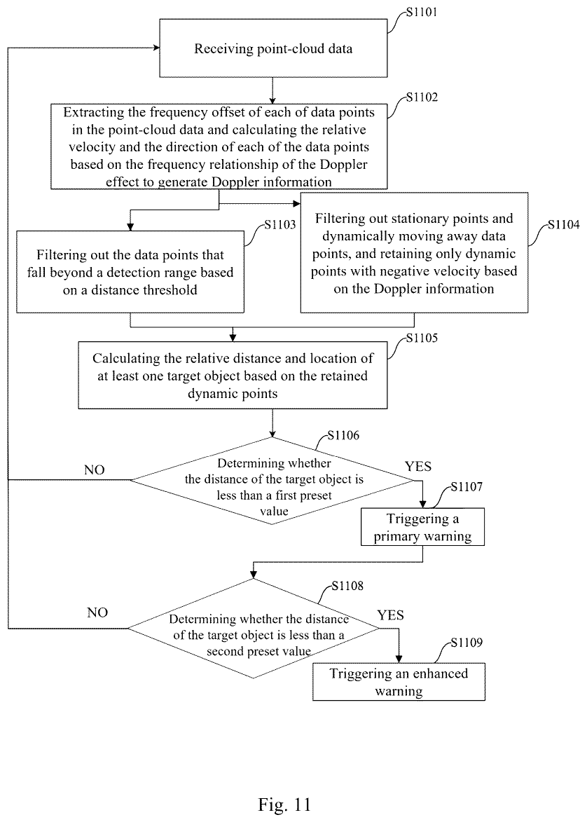

In conclusion, the warning device 100 can perform a series of processing and determination on the point-cloud data received by the radar module 140, especially the millimeter wave radar, to achieve the best warning effect. Please refer to FIG. 11.

FIG. 11 is a warning flowchart according to an embodiment of the present invention. The warning flowchart includes the following steps.

Step S1101: receiving point-cloud data. Firstly, the radar module 140 receives echo signals in the environment and generates point-cloud data. The point-cloud data includes multiple data points. Each data point records the distance, direction and other related parameters of the point.

Step S1102: extracting the frequency offset of each of data points in the point-cloud data and calculating the relative velocity and the direction of each of the data points based on the frequency relationship of the Doppler effect to generate Doppler information. In the step, the processing unit 151 extracts the frequency offset information from the echo signal and calculates the relative velocity value reflecting the motion direction and velocity of the target object, thereby providing a basis for the subsequent filtering step.

Step S1103: filtering out the data points that fall beyond a detection range based on a distance threshold. The processing unit 151 selects the point-cloud data to exclude the invalid data points that fall beyond the radar detection distance, thereby reducing unnecessary data processing burden.

Step S1104: filtering out stationary points and dynamically moving away points based on the Doppler information. The step selects dynamic points with negative velocity based on the Doppler information and retains only potential threat targets approaching the warning device 100, further improving the accuracy of the data.

Step S1105: calculating the relative distance and location of at least one target object based on the retained dynamic points. The processing unit 151 further analyzes the selected dynamic points and calculates the distance, the relative location, and the direction of the target object, thereby completing a preliminary threat assessment.

Step S1106: determining whether the distance of the target object is less than a first preset value. When the distance of the target object is less than the first preset value, the process proceeds to Step S1107 to trigger a primary warning. When the distance of the target object is not less than the first preset value, the process returns to Step S1101 to continue updating and determining the data.

Step S1107: triggering a primary warning. The controller 150 starts at least one warning lamp 112 to flash at a low frequency to warn other traffic participants in the environment.

Step S1108: determining whether the distance of the target object is less than a second preset value. When the distance of the target object is less than the second preset value, the process proceeds to Step S1109 to trigger an enhanced warning. When the distance of the target object is not less than the second preset value, the process returns to Step S1101 to collect new point-cloud data and continue monitoring the state of the target object.

Step S1109: triggering an enhanced warning. When the target object is at a dangerous distance, the controller 150 generates an enhanced warning instruction, starts the warning lamp 112 to flash at a high frequency, and starts the buzzer 170 to emit abnormal sounds to remind the driver and surrounding personnel to take emergency measures.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A warning device comprising:
a support stand;
a lamp board, having at least one warning lamp, arranged on the support stand;
an electronic component box arranged on the support stand;
a radar module arranged in the electronic component box and configured to detect at least one target object around the radar module to generate point-cloud data, wherein a distance between the radar module and the ground is greater than a given distance; and
a controller, comprising a processing module, electrically connected to the radar module and the at least one warning lamp, wherein the processing module is configured to:
extract a frequency offset of each of data points in the point-cloud data and calculate a relative velocity and a direction of each of the data points based on a frequency relationship of Doppler effect to generate Doppler information;
filter out the data points that fall beyond a detection range based on a distance threshold;
filter out stationary points and dynamically moving away points of the data points and retain dynamically approaching data points based on the Doppler information;
calculate a relative distance and a relative location of the at least one target object corresponding to the dynamically approaching points; and
turn on the at least one warning lamp or increase a flashing frequency of the at least one warning lamp when the at least one target object approaches the radar module.

2. The warning device according to claim 1, wherein the support stand comprises:
a support frame having at least one first connection point that is connected with the lamp board; and
a plurality of base legs each having at least one second connection point that is connected with a bottom surface of the support frame.

3. The warning device according to claim 2, wherein the support frame is folded at the at least one first connection point to overlap the lamp board, and each of the plurality of base legs rotates about the at least one second connection point to overlap the bottom surface of the support frame.

4. The warning device according to claim 1, further comprising a buzzer electrically connected to the controller, wherein the controller is configured to control the buzzer to emit warning sounds through a sound hole on a surface of the electronic component box.

5. The warning device according to claim 4, wherein the processing unit triggers a primary warning to generate a primary warning instruction when a distance of the at least one target object is less than a first preset value, the primary warning instruction starts the at least one warning lamp to flash at a low frequency, the processing unit triggers an enhanced warning to generate an enhanced warning instruction when a distance of the at least one target object is less than a second preset value, and the enhanced warning instruction starts the at least one warning lamp to flash at a high frequency and starts the buzzer to sound abnormally.

6. The warning device according to claim 5, wherein the processing unit is configured to adjust a flashing frequency of the at least one warning lamp and a sound volume of the buzzer based on a present relative velocity of the at least one target object.

7. The warning device according to claim 5, wherein the processing unit is further configured to:
calculate a reflective area of the at least one target object corresponding to at least one of the dynamic points of the data points;
select the at least one target object with the reflective area greater than a preset value as a vehicle for potential rear-end collision; and
continuously collect travel parameters of the vehicle, wherein the travel parameters include a location, a velocity, a direction, and a path.

8. The warning device according to claim 7, wherein the controller further comprises a prediction unit that is configured to:
collect the travel parameters of the vehicle;
combine with new point-cloud data to generate a predicted trajectory of the vehicle based on the travel parameters; and
immediately generate the enhanced warning instruction when determining that the predicted trajectory of the vehicle overlaps a location of the warning device.

9. The warning device according to claim 8, wherein the prediction unit is further configured to:
collect locations of other target objects around the vehicle; and
immediately generate the enhanced warning instruction when determining that the predicted trajectory of the vehicle after avoiding the other target objects overlaps a location of the warning device.

10. The warning device according to claim 5, further comprising a communication unit that generates and transmits a collision warning message to at least one adjacent communication device when the enhanced warning instruction is generated.

11. The warning device according to claim 8, further comprising a communication unit that generates and transmits a collision warning message to at least one adjacent communication device when the enhanced warning instruction is generated.

12. The warning device according to claim 9, further comprising a communication unit that generates and transmits a collision warning message to at least one adjacent communication device when the enhanced warning instruction is generated.
